(19) United States
(12) Patent Application Publication
(10) Pub. No.: US 2007/0185253 A1
(43) Pub. Date: Aug. 9, 2007

(54) RUBBER COMPOSITION AND PNEUMATIC TIRE USING THE SAME

(75) Inventor: Yoshihiko Suzuki, Tokyo (JP)

Correspondence Address: CONNOLLY BOVE LODGE & HUTZ LLP, 1875 EYE STREET, N.W., SUITE 1100, WASHINGTON, DC, 20036, US

(73) Assignee: The Yokohama Rubber Co., Ltd., Tokyo (JP)

(21) Appl. No.: 11/672,382

(22) Filed: Feb. 7, 2007

(30) Foreign Application Priority Data
Feb. 7, 2006 (JP) 2006-029469

(51) Int. Cl. C09B 67/00

(52) U.S. Cl. 524/502; 525/191; 525/494

(57) ABSTRACT

A rubber composition including 100 parts by weight of a rubber component composed of 50 to 80 parts by weight of natural rubber (NR) and/or polyisoprene rubber (IR), 15 to 45 parts by weight of polybutadiene rubber (BR) and 2 parts by weight to less than 10 parts by weight of a solution polymerized styrene-butadiene copolymer rubber (S-SBR) having a styrene content of 15 to 35% by weight and a vinyl bond content of a butadiene portion thereof of more than 30% to less than 75%.

### TECHNICAL FIELD

The present invention relates to a rubber composition and a pneumatic tire using the same, more particularly relates to a rubber composition having an improved fatigue breakage resistance suitable for use as a tire tread and a heavy duty pneumatic tire using the rubber composition for a cap tread part thereof.

### BACKGROUND ART

In the past, for the purpose of increasing the traction of heavy duty tires, tread designs having block shapes have been widely used. However, the stress due to repeated deformation during use tends to concentrate at the bottom of the grooves of the tire tread, and therefore, there was the problem of groove cracks (GC) or rib tear. Mostly caps composed of natural rubber (NR)/polybutadiene (BR) based formulation have been used (see Japanese Patent No. 2594809, Japanese Patent Publication (A) No. 8-225684, Japanese Patent Publication (A) No. 2000-225805 and Japanese Patent Publication (A) No. 2005-232407). The fatigue breakage resistance can be improved by increasing the ratio of the BR in the NR/BR formulating, but the problems newly arise in the chipping resistance along with the decrease in the breakage properties and in the slip and in the increased braking distance due to the decrease in the wet performance.

### DISCLOSURE OF THE INVENTION

Accordingly, an object of the present invention is to improve the fatigue breakage resistance of a rubber composition, particularly in both a grain direction and its perpendicular direction.

In accordance with the present invention, there is provided a rubber composition comprising 100 parts by weight of a rubber component comprising 50 to 80 parts by weight of natural rubber (NR) and/or polyisoprene rubber (IR), 15 to 45 parts by weight of polybutadiene rubber (BR), and 2 parts by weight to less than 10 parts by weight of a solution-polymerized styrene-butadiene copolymer rubber (i.e., S-SBR) having a styrene content of 15 to 35% by weight and a vinyl bond content of a butadiene part of more than 30 to less than 75%.

In accordance with the present invention, there is also provided a rubber composition comprising 35 to 60 parts by weight of carbon black based upon 100 parts by weight of the above-mentioned rubber composition.

In accordance with the present invention, there is further provided a pneumatic tire using as a cap tread part thereof, the above-mentioned rubber composition.

According to the present invention, by blending a small amount of S-SBR having a specific microstructure to the NR/BR, it is possible to improve the fatigue breakage resistance of the rubber composition. Further, the effect of improvement in the fatigue breakage resistance is observed both in the grain direction and its perpendicular direction and the elongation at break and tanδ at a low temperature of the rubber composition become larger (i.e., the braking performance on wet roads is excellent).

### BEST MODE FOR CARRYING OUT THE INVENTION

The inventors engaged in research to solve the above-mentioned problems and, as a result, found the present invention.

Namely, when a rubber composition is extruded from an extruder, the rubber molecules are generally orientated in the extrusion direction. As a result, the grain effect is generated, and therefore, when a repeated constant strain fatigue test is carried out, the times, when the samples are broken, are increased for the samples stretched in the extrusion direction, when compared with those stretched in the direction perpendicular or vertical to the extrusion direction.

On the other hand, in the manufacture of a pneumatic tire, in addition to the grain effects in the extrusion direction, when the tire is vulcanized in a mold, especially in the case of having block patterns such as a traction pattern, the cracks are generated at the bottoms of the channels due to the addition of various complicated strains at the bottoms of the channels formed in the tire patterns when vulcanized. As the action from the compounding of tire tread rubbers, various blends of natural rubber (NR)/polybutadiene rubber are usually used so as to improve the fatigue breakage resistance. However, in the past, the improvement of the fatigue breakage resistance in the repeated constant-strain fatigue test in the direction perpendicular to the extrusion grain direction is not observed, when compared with the improvement in the extrusion grain direction.

Contrary to the above, according to the present invention, by compounding a small amount of S-SBR having a specific microstructure to NR/BR, the fatigue breakage resistance can be improved. Further, the effect of improvement in the fatigue breakage resistance was recognized in both the grain direction and its perpendicular direction. This is especially advantageous especially for suppressing the generation of cracks in the bottoms of the channels of tires having block patterns such as traction patterns. Therefore, the inventors found that it becomes possible to suppress the increase in the ratio of the BR to improve the fatigue breakage resistance, that not only can the decrease in the breakage properties be suppressed, but also the decrease in the tanδ at a low temperature can be suppressed, and the decrease in the wet performance can also be suppressed.

The microstructure of the solution polymerization styrene-butadiene copolymer rubber (S-SBR) usable in the present invention is a styrene content of 15 to 35% by weight, preferably 17 to 30% by weight, and a vinyl bond content of the butadiene portion of more than 30% to 75%, preferably 32% to 72%. When the above-mentioned S-SBR is used in an amount of 2 parts by weight to less than 10 parts by weight, preferably 4 to 9.5 parts by weight, based upon 100 parts by weight of the rubber component, the above-mentioned effect can be expressed. If the amount of the S-SBR is small, the effect of the improvement in the present invention unpreferably becomes insufficient, while conversely if the amount is large, the elongation at break is decreased and the chipping resistance performance is decreased and, therefore, this is not preferred. The S-SBR is a known rubber. For example, Nippon Zeon's Nipol NS116R, Asahi Kasei's Asaprene 1204, and other commercially available products may be used.

From the viewpoint of obtaining the high breakage properties, the rubber component blended into the rubber composition according to the present invention is composed of, based upon 100 parts by weight of the total weight of the rubber components, natural rubber (NR) and/or polyisoprene rubber (IR) in an amount of 50 to 80 parts by weight, preferably 55 to 70 parts by weight, polybutadiene rubber (BR) in an amount of 15 to 45 parts by weight, preferably 20 to 40 parts by weight, and the above-mentioned S-SBR having a styrene content of 15 to 35% by weight and a vinyl bond content of the butadiene part of more than 30% to 75% in an amount of 2 parts by weight to less than 10 parts by weight.

According to a preferable embodiment of the present invention, carbon black is compounded, into the rubber composition, in an amount of 35 to 60 parts by weight, preferably 40 to 55 parts by weight, based upon 100 parts by weight of the rubber component. This rubber composition can be used, for example, as a cap tread part of a heavy duty pneumatic tire.

The carbon black usable in the present invention is not particularly limited and can be suitably selected and used by a person skilled in the art depending upon the application of use. If the amount of the carbon black is too small, the product lifetime is liable to decrease along with the decrease in the abrasion resistance, and therefore this is not preferred, while conversely if the amount is too large, the durability is liable to be decreased due to the heat buildup in the tire, and therefore this is also not preferred.

The rubber composition according to the present invention can be used as a member of a pneumatic tire, for example, a tread part, by a general method. The production method is not different from that of the past.

The rubber composition according to the present invention may contain, in addition to the above-mentioned components, other fillers such as silica, a vulcanization or cross-linking agent, a vulcanization or cross-linking accelerator, various types of oils, an antioxidant, a plasticizer, or other various types of additives generally compounded in the tire use or other rubber compositions. The additives may be mixed by a general method to obtain a composition for vulcanization or cross-linking. The amounts of these additives may be used in conventional general amounts, unless the objects of the present invention are affected.

### EXAMPLES

Examples will now be further explained the present invention, but the scope of the present invention is by no means limited to these Examples.

### Standard Example 1, Examples 1 to 4 and Comparative Examples 1 to 9

### Preparation of Samples

In each of the formulations (parts by weight) shown in Table I, the components other than the vulcanization accelerator and sulfur were mixed by a BB-2 type mixer at a temperature of 60° C., a speed of 30 rpm and a discharge temperature of 130° C., then the sulfur/vulcanization accelerator were charged by an open roll and the mixture was cut 10 times each left and right, then press vulcanized at 150° C. for 30 minutes to prepare a 2 mm thick vulcanized rubber sheet. The vulcanized rubber sheet thus obtained was used to measure the physical properties of the vulcanized rubber by the following test methods. The results are shown in Table I.

### Test Method for Evaluation of Rubber Physical Properties Constant Strain Sheet Fatigue

A No. 3 dumbbell punched out from the above vulcanized sheet was repeatedly given 60% strain according to JIS K6251 method and was measured for number of cycles until breakage. The number of cycles until breakage was measured by n=6. From the number of cycles until breakage, the 50% residual probability by normal probability distribution was found and indexed to the value of Comparative Example 2 as 100. The larger this value, the longer the fatigue life and the better the fatigue breakage resistance indicated.

### Tensile Test

A No. 3 dumbbell cut test piece was punched out from the vulcanized sheet and measured for elongation at break at room temperature and 100° C. according to JIS K6251 method. This was indexed to the value of Comparative Example 2 as 100. The larger this value, the greater the elongation at break and the better the chipping resistance indicated.

### Viscoelastic Spectrometer

A viscoelastic spectrometer made by Toyo Seiki Seisaku-sho was used to measure the tanδ under conditions of a strain of 10±2%, a frequency of 20Hz and an ambient temperature of 0° C. The measurement results were indexed to the value of Comparative Example 2 as 100. The larger this value, the larger the tanδ at a low temperature and the more advantageous in terms of braking performance on a wet road surface.

### Tire Evaluation

A 315/80R22.5 traction type (block pattern) tire was prepared using each of the rubber compositions shown in Table I as the cap tread. This was mounted on a drive shaft of a 4×2 tractor and run on for 100,000 km under conditions of the legal load and a highway/ordinary road ratio of 50% or less. Thereafter, the surface of the cap tread was examined to check for the presence of any cracks at the bottom of the grooves of the cap. No cracks was scored as 5 points and the worst state as 1 point for scoring by a five-point system. The higher the points, the better the group crack resistance indicated.

TABLE I

| | Stand. | Comp. | Comp. | Comp. | | | | |
|---|---|---|---|---|---|---|---|---|
| | Ex. 1 | Ex. 1 | Ex. 2 | Ex. 3 | Ex. 1 | Ex. 2 | Ex. 3 | Ex. 4 |
| Formulation (parts by weight) | | | | | | | | |
| NR(RSS#3) | 100 | 65 | 60 | 55 | 60 | 55.5 | 60 | 55.5 |
| BR(Nippon Zeon Nipol 1220) | — | 35 | 40 | 45 | 35 | 35 | 35 | 35 |
| SBR1(Asahi Kasei Asaprene 1204) *1 | — | — | — | — | 5 | 9.5 | — | — |
| SBR2(Nippon Zeon Nipol NS116R) *1 | — | — | — | — | — | — | 5 | 9.5 |
| SBR3(Nippon Zeon Nipol 1502) *1 | — | — | — | — | — | — | — | — |
| SBR4(Asahi Kasei Asaprene ESR-10) *1 | — | — | — | — | — | — | — | — |
| SBR5(Nippon Zean Nipol NS110) *1 | — | — | — | — | — | — | — | — |
| SBR6(Asahi Kasei Tufden 1000R) *1 | — | — | — | — | — | — | — | — |
| Carban black (Mitsubishi Chemical, | 50 | 50 | 50 | 50 | 50 | 50 | 50 | 50 |
| Dia A) | | | | | | | | |
| Antioxidant (Sumitomo Chemical, | 1 | 1 | 1 | 1 | 1 | 1 | 1 | 1 |
| Antigen 6C) | | | | | | | | |
| Stearic acid (Chiba Fatty Acid, | 3 | 3 | 3 | 3 | 3 | 3 | 3 | 3 |
| Industrial Stearic Acid) | | | | | | | | |
| Zinc White (Seido Chemical Industry, | 3 | 3 | 3 | 3 | 3 | 3 | 3 | 3 |
| Zinc White No. 3) | | | | | | | | |
| Vulcanization accelerator CZ (Sanshin | 1.2 | 1.2 | 1.2 | 1.2 | 1.2 | 1.2 | 1.2 | 1.2 |
| Chemical Industry, Sanceler CM-G) | | | | | | | | |
| Sulfur (Karuizawa Refinery, 5% oil | 1.5 | 1.5 | 1.5 | 1.5 | 1.5 | 1.5 | 1.5 | 1.5 |
| extended sulfur) | | | | | | | | |
| Evaluated Properties | | | | | | | | |
| Constant strain sheet fatigue | | | | | | | | |
| Fatigue life index: | | | | | | | | |
| 0 degree with respect to sheet feed | 24 | 92 | 100 | 108 | 108 | 109 | 114 | 112 |
| out direction | | | | | | | | |
| 90 degrees with respect to sheet | 26 | 96 | 100 | 103 | 109 | 113 | 118 | 113 |
| feed out direction | | | | | | | | |
| Tensile test | | | | | | | | |
| Elongation at break index: | | | | | | | | |
| Blank (room temperature) | 111 | 101 | 100 | 97 | 101 | 101 | 100 | 100 |
| Blank (100° C.) | 147 | 114 | 100 | 96 | 102 | 103 | 101 | 100 |
| Viscoelasticity spectrometer (20, 1, | 119 | 104 | 100 | 97 | 105 | 111 | 105 | 107 |
| 20 Hz, 10%2 ± %, 5 mm, 2 mm, 20 mm) | | | | | | | | |
| tanδ index (0° C.) | | | | | | | | |
| Tire evaluation | 1 | 2 | 3 | 4 | 5 | 5 | 5 | 5 |
| Group crack resistance index | | | | | | | | |

| | Comp. | Comp. | Comp. | Comp. | Comp. | Comp. |
|---|---|---|---|---|---|---|
| | Ex. 4 | Ex. 5 | Ex. 6 | Ex. 7 | Ex. 8 | Ex. 9 |
| Formulation (parts by weight) | | | | | | |
| NR(RSS#3) | 60 | 60 | 60 | 60 | 64 | 50 |
| BR(Nippon Zeon Nipol 1220) | 35 | 35 | 35 | 35 | 34 | 35 |
| SBR1(Asahi Kasei Asaprene 1204) *1 | 5 | — | — | — | — | — |
| SBR2(Nippon Zeon Nipol NS116R) *1 | — | — | — | — | 1 | 15 |
| SBR3(Nippon Zeon Nipol 1502) *1 | 5 | — | — | — | — | — |
| SBR4(Asahi Kasei Asaprene ESR-10) *1 | — | 5 | — | — | — | — |
| SBR5(Nippon Zean Nipol NS110) *1 | — | — | 5 | — | — | — |
| SBR6(Asahi Kasei Tufden 1000R) *1 | — | — | — | 5 | — | — |
| Carban black (Mitsubishi Chemical, | 50 | 50 | 50 | 50 | 50 | 50 |
| Dia A) | | | | | | |
| Antioxidant (Sumitomo Chemical, | 1 | 1 | 1 | 1 | 1 | 1 |
| Antigen 6C) | | | | | | |
| Stearic acid (Chiba Fatty Acid, | 3 | 3 | 3 | 3 | 3 | 3 |
| Industrial Stearic Acid) | | | | | | |
| Zinc White (Seido Chemical Industry, | 3 | 3 | 3 | 3 | 3 | 3 |
| Zinc White No. 3) | | | | | | |
| Vulcanization accelerator CZ (Sanshin | 1.2 | 1.2 | 1.2 | 1.2 | 1.2 | 1.2 |
| Chemical Industry, Sanceler CM-G) | | | | | | |
| Sulfur (Karuizawa Refinery, 5% oil | 1.5 | 1.5 | 1.5 | 1.5 | 1.5 | 1.5 |
| extended sulfur) | | | | | | |
| Evaluated Properties | | | | | | |
| Constant strain sheet fatigue | | | | | | |
| Fatigue life index: | | | | | | |
| 0 degree with respect to sheet feed | 107 | 76 | 104 | 104 | 94 | 104 |
| out direction | | | | | | |
| 90 degrees with respect to sheet | 97 | 94 | 98 | 100 | 96 | 100 |
| feed out direction | | | | | | |
| Tensile test | | | | | | |
| Elongation at break index: | | | | | | |
| Blank (room temperature) | 102 | 100 | 101 | 102 | 100 | 97 |
| Blank (100° C.) | 106 | 116 | 100 | 100 | 101 | 95 |
| Viscoelasticity spectrometer (20, 1, | 111 | 108 | 105 | 105 | 105 | 109 |
| 20 Hz, 10%2 ± %, 5 mm, 2 mm, 20 mm) | | | | | | |
| tanδ index (0° C.) | | | | | | |
| Tire evaluation | — | 2 | — | — | 3 | 4 |
| Group crack resistance index | | | | | | |

*1: See Table II

TABLE II
Microstructure of S-SBR

| | Styrene | | | | |
|---|---|---|---|---|---|
| | content | Microstructure of | | | Glass |
| | St. | butadiene part | | | transition |
| | % by | | trans | vinyl | point |
| S-SBR | weight | cis % | % | % | Tg ° C. |
| SBR-1(made by Asahi Kasei, | 25.2 | 23.7 | 43.9 | 32.4 | −54.0 |
| Asaprene 1204) | | | | | |
| SBR-2(made by Nippon Zeon, | 22.8 | 10.3 | 20 | 69.7 | −22.4 |
| Nipol NS116R) | | | | | |
| SBR-3(made by Nippon Zeon, | 24.2 | 10.5 | 73.8 | 15.7 | −54.4 |
| Nipol 1502) | | | | | |
| SBR-4(made by Asahi Kasei, | 42.2 | 23.9 | 41.6 | 34.5 | −23.6 |
| Asaprene ESR-10) | | | | | |
| SBR-5(made by Nippon Zeon, | 12.0 | 8.0 | 23.0 | 69.0 | −24.0 |
| Nipol NS110) | | | | | |
| SBR-6(made by Asahi Kasei, | 18.5 | 35.7 | 55 | 9.3 | −73.1 |
| Tufden 1000R) | | | | | |

As is clear from the results of Table I, Comparative Examples 1 to 3 are greatly improved in fatigue breakage resistance compared with Standard Example 1 as the BR becomes greater in the ratio of NR/BR, but decrease the elongation at break and decrease the tanδ at a low temperature. As opposed to this, Examples 1 to 4 according to the present invention, by the inclusion of S-SBR in 5 to 10 parts by weight, are further improved in fatigue breakage resistance in both the sheet feed out direction 0/90 degrees and are also improved in elongation at break and tanδ at a low temperature, compared with Comparative Example 2 having an NR/BR ratio (weight ratio) of 60/40. The groove crack resistance in a driving test, using pneumatic tires, is also greatly improved.

Comparative Example 4 shows that, when using S-SBR having a small vinyl bond content, no improvement is seen in the fatigue breakage resistance in the direction 90 degrees with respect to the sheet feed out direction (grain direction), while Comparative Example 5 shows that, when using S-SBR having a vinyl bond content within the scope of the present invention, but with a large styrene content, the fatigue breakage resistance is decreased. Comparative Example 6 shows that, when using S-SBR having a vinyl bond content within the scope of the present invention, but with a small styrene content, no improvement is seen in the fatigue breakage resistance in the direction 90 degrees with respect to the sheet feed out direction, while Comparative Example 7 shows, when using S-SBR, having a small vinyl bond content/styrene content, no improvement is seen in the fatigue breakage resistance in the direction 90 degrees with respect to the sheet feed out direction. Comparative Example 8 shows that, even if using the S-SBR according to the present invention, if the amount compounded is small, no improvement is seen in the fatigue breakage resistance, while Comparative Example 9 shows that, even if using the S-SBR according to the present invention, if the amount compounded is large, the improvement in the fatigue breakage resistance becomes smaller and the decrease in the elongation at break becomes remarkable.

As explained above, according to the present invention, by compounding a small amount of S-SBR having a specific microstructure to the NR/BR rubber blend, the fatigue breakage resistance can be improved. Further, an effect of improvement in the fatigue breakage resistance is seen in both the grain direction and its perpendicular direction. This is optimal for use, for example, as the cap tread of a heavy duty pneumatic tire of a truck, bus, etc.

1. A rubber composition comprising 100 parts by weight of a rubber component containing 50 to 80 parts by weight of natural rubber (NR) and/or polyisoprene rubber (IR), 15 to 45 parts by weight of polybutadiene rubber (BR) and 2 parts by weight to less than 10 parts by weight of a solution-polymerized styrene-butadiene copolymer rubber (S-SBR) having a styrene content of 15 to 35% by weight and a vinyl bond content of a butadiene portion thereof of more than 30 to less than 75%.

2. A rubber composition as claimed in claim 1 comprising 35 to 60 parts by weight of carbon black, based upon 100 parts by weight of the rubber component according to claim 1.

3. A pneumatic tire using, as a cap tread part thereof, a rubber composition according to claim 1.
